(19) United States
(12) Patent Application Publication
(10) Pub. No.: US 2018/0121339 A1
(43) Pub. Date: May 3, 2018

(54) System and Method for Testing Behavior of Web Application Software

(71) Applicant: ServiceNow, Inc., Santa Clara, CA (US)

(72) Inventors: Anson Barber Mayers, San Rafael, CA (US); Jared Laethem, Carlsbad, CA (US)

(21) Appl. No.: 15/341,593

(22) Filed: Nov. 2, 2016

(51) Int. Cl. G06F 11/36

(52) U.S. Cl. CPC G06F 11/3688

(57) ABSTRACT

Testing behavior of a first instance of web application software can include receiving a request from a first window of a web browser instance executed on a client device indicating a test of one or more components of the first instance. Instructions can be sent to the first window to cause the web browser instance to open a second window of the web browser instance and request a webpage from the first instance from the second window. The webpage can be sent to the client device responsive to another request for the webpage received from the second window. Instructions can be sent to the second window to perform the test using the second window and the webpage. Test results can be received from the second window responsive to a performance of the test against the one or more components.

### TECHNICAL FIELD

This disclosure relates in general to testing behavior of web application software in an electronic computing and communications system.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Web application software can be provided, for example, by a Platform-as-a-Service (PaaS) or other provider or can be hosted by an individual or organization using the software. In some cases, the web application software may be developed or configured using software services provided by a third-party. For example, platform software provided by a PaaS provider (e.g., hosted by servers in datacenters around the globe) can be customized using scripts or other instructions to develop “cloud-based” application software. The platform software can use data, which can be stored in a database, to process information in connection with a customized application software instance. In this way, the application software can be executed by servers operated by a PaaS provider, and clients can use the application software by communicating with the servers over protocols, such as HTTP.

The PaaS provider may update the platform software, such as to add or remove functionality or to correct errors in the software. When the platform software is updated, the data can be changed, as well. The updating of the platform software or the associated data may result in unexpected or undesired changes in functionality.

### BRIEF DESCRIPTION OF THE DRAWINGS

The description herein makes reference to the accompanying drawings, wherein like reference numerals refer to like parts throughout the several views.

FIG. 1 is a block diagram of an example of an electronic computing and communications system.

FIG. 2 is a block diagram of an example of an internal configuration of a computing device of an electronic computing and communications system.

FIG. 3 is a block diagram of an example of states of a production instance and a test instance of platform software.

FIG. 4 is a block diagram of an example of client-server communications for testing behavior of an instance of web application software.

FIGS. 5A-E are block diagrams of examples of requests, instructions, or other data communicated in connection with testing behavior of an instance of web application software.

FIG. 6 is an illustration of an example of a graphical user interface showing a component of an instance of web application software.

FIG. 7 is an illustration of an example of a graphical user interface of a dashboard for configuring and performing tests for testing behavior of an instance of web application software.

FIG. 8 is an illustration of an example of a graphical user interface showing the component of the instance of web application software of FIG. 6 updated responsive to a test performed against it.

FIG. 9 is a flowchart illustrating an example of a technique for testing behavior of an instance of web application software using windows of a web browser instance.

### DETAILED DESCRIPTION

An electronic computing and communications system can include computing devices for delivering software services over a computer network. Various configurations of the computing devices and software services are available within the electronic computing and communications system. In some cases, the electronic computing and communications system can include a datacenter having server devices for delivering distributed web application software services to customers of a cloud computing service provider. For example, the service provider can operate platform software on the server devices as part of a PaaS cloud computing environment.

Platform software can, for example, be implemented such that the platform software has a version. For example, when platform software is modified, the original platform software can have a first version number and the modified platform software can have a second version number. When an instance of platform software is installed, it can be connected to a database or other data structure that includes data used by the platform software to determine how the platform software should execute. For example, the data can include tables of menus, forms, lists, scripts, or the like that the platform software can use to respond to user requests, execute between requests, or combinations thereof. For example, the platform software can include a dictionary of information relating to the database structure or contents (or other structure used to store the data, as applicable) to permit customization, modification, or addition to the data usable by the platform. For example, a customer of a PaaS service provider, or another user, may be able to add tables, columns, scripts, or the like to the database.

When installed, a version of platform software can populate the database with data needed to run the platform software instance. In addition, the platform software can include one or more applications or plugins that can further populate or change the data used by the platform software. This data provided by the platform software or otherwise initially included in the data can be referred to as “platform data.” Users of the platform software can configure, customize, modify, add, or delete platform data used by the platform software. However, in some cases, some of the platform data can be restricted (e.g., it might not be modifiable or able to be deleted). Data created or modified by a user can be interchangeably referred to as “customized data,” “user data,” or the like. Thus, user data can include new data (e.g., provided by a user), data that was previously platform data (e.g., where platform data is modified, such as by a user), or combinations thereof.

Customers of the PaaS service provider can, for example, be provided an instance of the platform software, which can be provisioned using application nodes and database nodes executing in a datacenter. For example, a customer may be permitted to configure or modify the platform software, or develop application software using the platform software and which can be used by clients of the customer. For example, the platform software can be configured or modified by implementing additions, changes, deletions, or the like, or combinations thereof, to data, such as platform data, stored in a database and used by the platform software. Similarly, for example, application software can be developed using the platform software, which can result in changes being made to the platform data stored in the database (e.g., based on the introduction of user data). The changes to the platform data can, for example, change or add to the functionality of the platform software, such as by causing the platform software to use platform functionality in new ways to provide new or modified services. In some cases, the electronic computing and communications system can include platform software executed on one or more server devices outside of a PaaS cloud computing environment (e.g., where the platform software is used as on-premises software).

Web application software, such as platform software, can be configured, modified, or customized to add, remove, or otherwise alter the functionality of the platform software (e.g., based on changes made to the platform data stored in a database used by the platform software). For example, an instance of platform software can be configured to permit a user to add, change, or modify database tables, scripts, configurations, or other data used by the platform software to respond to client requests, send requests to other devices, or the like. In some cases, the alterations to data used by the platform software can be in the form of creating new application software running on the platform that can, for example, include a new or modified set of functionality available to users of the platform instance.

In some cases, the platform software can be updated by upgrading the platform software from a first software version to a second software version. The upgrade can affect the configurations, modifications, or application software made by a customer using the platform software. As such, the functionality of the platform software (or other types of web application software, as applicable) after an update to the platform software version can be tested to find impairments to the functionality of the platform software instance that might have been caused by the update. Updates to the configurations, modifications, or application software of the platform instance may be needed in order for the configurations, modifications, or applications to work as desired using the updated platform software version. Current processes for identifying an applying such updates may require manual effort, be time-consuming and be prone to error. For example, because an instance of platform software can include a large number of elements, testing the elements of the instance of the platform software can take a substantial amount of time.

Implementations of this disclosure may address problems such as those described above by configuring or automating testing of updated software, automating identification or application of updates to an instance of platform software based on the testing, providing a copy of a platform software instance to facilitate testing, or combinations thereof. In an implementation, the behavior of a first instance of platform software can be tested in connection with an update to the first instance. The test can be configured, automated, and performed using a plurality of windows of a web browser instance executing on a client. A request for the test, which can be a test of one or more components of the first instance of platform software, can be generated using a first webpage processed by a first window of the web browser instance. Instructions can be received from the first instance of platform software that, when processed by the first window, cause the web browser instance to open a second window configured to receive a second webpage. Instructions can be received from the first window to initiate a performance of the test in the second window using the second webpage. In this way, the performance of the configured test can be automated to reduce the amount of time and improve the process for testing the first instance of platform software in view of the update.

Implementations of this disclosure provide technological improvements particular to computer networks, for example, those concerning testing behavior of web application software within a distributed computer system based on changes to be made to a database accessible by the web application software. Computer network-specific technological problems, such as the configuring or automating of web application software tests in a distributed computer system, can be wholly or partially solved by implementations of this disclosure. For example, a server on which an instance of the web application software executes can control a test of components of the instance using a web browser instance executing on a client. The implementations of this disclosure introduce new and efficient improvements in the ways in which a server can control a test of components of an instance of web application software by sending instructions that, when processed by windows of the web browser instance executing on the client, cause the web browser instance to perform the test.

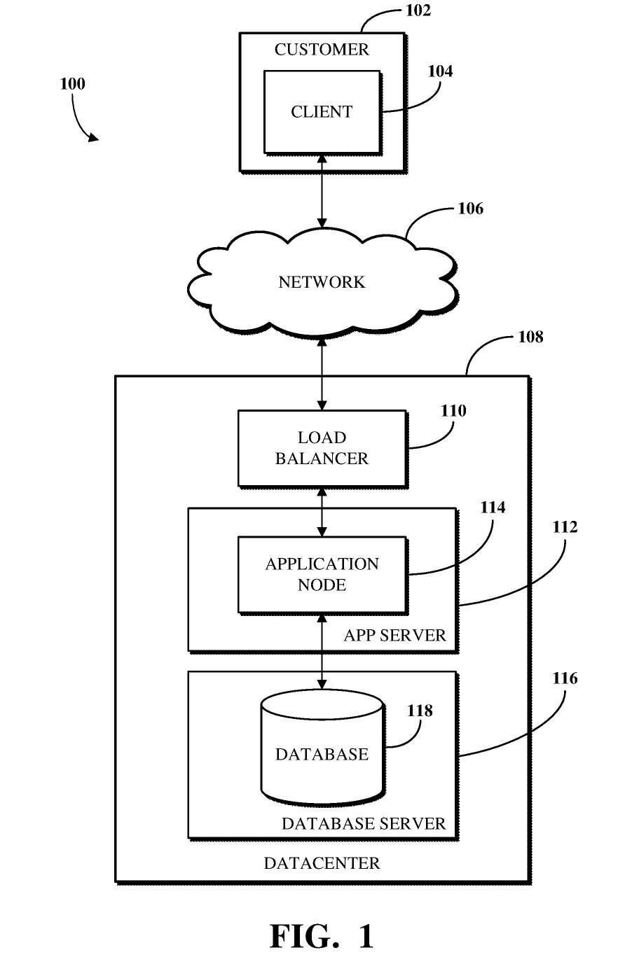

To describe some implementations in greater detail, reference is first made to examples of hardware structures. FIG. 1 is a block diagram of an example of an electronic computing and communications system 100. As used herein, the term “electronic computing and communications system,” or variations thereof, can be, or include, a distributed computing system (e.g., a client-server computing system), a cloud computing system, a clustered computing system, or the like.

The system 100 can include one or more customers 102, which may be a public entity, private entity, or other corporate entity or individual that purchases or otherwise uses services of a software provider, such as a PaaS service provider. The customer 102 can include one or more clients. For example, and without limitation, the customer 102 can include a client 104. The client 104 can comprise a computing system, which can include one or more computing devices, such as a mobile phone, a tablet computer, a laptop computer, a notebook computer, a desktop computer, or any other suitable computing device or combination of computing devices. In some implementations, the client 104 can be implemented as a single physical unit or as a combination of physical units. In some implementations, a single physical unit can include multiple clients.

The client 104 can be an instance of an application running on a customer device associated with the customer 102. As used herein, the term “software” can include, but is not limited to, applications, programs, instances, processes, threads, services, plugins, patches, application version upgrades, or any other identifiable computing aspect capable of accessing or interacting with, directly or indirectly, a database. The system 100 can include any number of customers or clients or can have a configuration of customers or clients different from that generally illustrated in FIG. 1. For example, and without limitation, the system 100 can include hundreds or thousands of customers, and at least some of the customers can include or be associated with any number of clients. A customer can include a customer network or domain. For example, and without limitation, the client 104 can be associated or communicate with a customer network or domain.

The system 100 can include a datacenter 108. The datacenter 108 can include one or more servers. For example, and without limitation, the datacenter 108, as generally illustrated, includes an application server 112 and a database server 116. A datacenter, such as the datacenter 108, can represent a geographic location, which can include a facility, where the one or more servers are located. The system 100 can include any number of datacenters and servers or can include a configuration of datacenters and servers different from that generally illustrated in FIG. 1. For example, and without limitation, the system 100 can include tens of datacenters, and at least some of the datacenters can include hundreds or any suitable number of servers. In some implementations, the datacenter 108 can be associated or communicate with one or more datacenter networks or domains, which can include domains other than the client domain.

The client 104 and the servers associated with the datacenter 108 may be configured to connect to, or communicate via, a network 106. Furthermore, a client 104 associated with the customer 102 can connect to the network 106 via a communal connection point, link, or path or using a distinct connection point, link, or path. A connection point, link, or path can be wired, wireless, use other communications technologies, or a combination thereof.

The network 106 can include, for example, the Internet and/or the network 106 can be, or include, a local area network (LAN), a wide area network (WAN), a virtual private network (VPN), or any other public or private means of electronic computer communication capable of transferring data between a client, such as the client 104, and one or more servers associated with the datacenter 108, or a combination thereof. The network 106, the datacenter 108, or any other element, or combination of elements, of the system 100 can include network hardware such as routers, switches, load balancers, other network devices, or combinations thereof. For example, the datacenter 108 can include a load balancer 110 for routing traffic from the network 106 to various servers associated with the datacenter 108.

The load balancer 110 can route, or direct, computing communications traffic, such as signals or messages, to respective elements of the datacenter 108. For example, the load balancer 110 can operate as a proxy, or reverse proxy, for a service, such as an Internet-delivered service, provided by the datacenter 108 to one or more remote clients, such as the client 104, via the network 106. Routing functions of the load balancer 110 can be configured directly or via a Domain Name System (DNS). The load balancer 110 can coordinate requests from remote clients, such as the client 104, and can simplify client access by masking the internal configuration of the datacenter 108 from the remote clients. Request coordination can include maintaining information for sessions, such as sticky sessions, between a client and a service or application provided by the datacenter 108.

Maintaining information for a sticky session can include maintaining information to forward requests associated with a session from a client to an identified element of the datacenter 108 for the session. A load balancer 110 can operate as a firewall, allowing or preventing communications based on configuration settings. Although the load balancer 110 is depicted in FIG. 1 as being within the datacenter 108, in some implementations, the load balancer 110 can instead be located outside of the datacenter 108, for example, when providing global routing for multiple datacenters. In some implementations, load balancers can be included both within and outside of the datacenter 108.

The datacenter 108 may include an application server 112 and a database server 116. The application server 112 or the database server 116 can be a computing system, which can include one or more computing devices, such as a desktop computer, a server computer, or any other computer capable of operating as a server. In some implementations, the application server 112 or the database server 116 can be non-hardware servers implemented on a physical device, such as a hardware server. In some implementations, the application server 112 and the database server 116 can be implemented as a single hardware server or as a single non-hardware server implemented on a single hardware server. Of course, any number of application servers or database servers can be implemented at the datacenter 108, and the datacenter 108 can include servers other than or in addition to the application server 112 or the database server 116, for example, a web server.

In some implementations, the application server 112 includes an application node 114, which can be a process executed on the application server 112. For example, and without limitation, the application node 114 can be executed in order to deliver services to a client, such as the client 104, as part of a web application. The application node 114 can be implemented using processing threads, virtual machine instantiations, or other computing features of the application server 112. In some implementations, the application node 114 can store, evaluate, or retrieve data from a database, such as the database 118 of the database server 116.

The application server 112 can include any suitable number of application nodes, depending upon a system load or other characteristics associated with the application server 112. For example, and without limitation, the application server 112 can include two or more nodes forming a node cluster. The application nodes implemented on a single application server 112 may run on different hardware servers.

The database server 116 can be configured to store, manage, or otherwise provide data for delivering services to the client 104 over a network. The database server 116 may include a data storage unit, such as a database 118, which can be accessible by an application executed on the application node 114. The database 118 may be implemented as a relational database management system (RDBMS), an object database, an XML database, a configuration management database (CMDB), a management information base (MIB), one or more flat files, other suitable non-transient storage mechanisms, or a combination thereof. By way of non-limiting example, the system 100, in some implementations, can include an XML database and a CMDB. While limited examples are described, the database 118 can be configured as or comprise any suitable database type. Further, the system 100 can include one, two, three, or any suitable number of databases configured as or comprising any suitable database type or combination thereof.

In some implementations, the database 118 can be configured as or comprise a CMDB. A CMDB can comprise a plurality of configuration items (CIs), attributes associated with the CIs, or relationships between the CIs. A CI can be a CMDB record that represents an infrastructure entity, device, or units of the system 100. For example, the customer 102, the client 104, the network 106, the datacenter 108, the load balancer 110, the application server 112, the application node 114, the database server 116, the database 118, or any other element, portion of an element, or combination of elements of the electronic computing and communications system 100 can be represented in the CMDB by a CI.

The CMDB can include information describing the configuration, the role, or both the configuration and the role, of an element of the system 100. In some implementations, an MIB can include one or more databases listing characteristics of the elements of the system 100. In some implementations, an object identifier (OID) can represent object identifiers of objects or elements in the MIB.

One or more databases (e.g., the database 118), tables, other suitable information sources, or portions or combinations thereof may be stored, managed, or otherwise provided by one or more of the elements of the system 100 other than the database server 116, such as the client 104 or the application server 112.

Some or all of the systems and methods described herein can operate or be executed on or by the servers associated with the system 100. For example, an update for an application executed on the application node 114 can include updating or upgrading the database 118. In some implementations, the systems and methods described herein, portions thereof, or combinations thereof can be implemented on a single device, such as a single server, or a combination of devices, for example, a combination of the client 104, the application server 112, and the database server 116.

In some implementations, the system 100 can include devices other than the client 104, the load balancer 110, the application server 112, and the database server 116 as generally illustrated in FIG. 1. In some implementations, one or more additional servers can operate as an electronic computing and communications system infrastructure control, from which servers, clients, or both servers and clients, can be monitored, controlled, configured, or a combination thereof.

The network 106, one or more datacenters, such as the datacenter 108, and one or more load balancers, such as the load balancer 110, may be implemented within a distributed computing system. A load balancer associated with a distributed computing system (e.g., the load balancer 110) can communicate with the network 106, one or more datacenters (e.g., the datacenter 108), other load balancers, or a combination thereof. The load balancer 110 can be configured to route communications to a primary datacenter, identify a failover condition (e.g., an enumerated failover condition) at the primary datacenter, and redirect communications to a secondary datacenter until the failover condition is resolved. Although illustrated as a single unit in FIG. 1, a load balancer 110 can be implemented as multiple physical or logical units. For example, a distributed computing system can include distinct routing units, load balancing units, firewall units, or the like.

The primary datacenter can include a primary database, such as the database 118, and the secondary datacenter can include a secondary database. The secondary database can include an exact or substantially exact mirror, copy, or replication of the primary database. The primary database or the secondary database can be implemented as an RDBMS, an object database, an XML database, one or more flat files, or the like.

An application node implemented within a distributed computing environment can connect to or communicate with the primary database, which can be associated with the datacenter with which the application node is associated, or associated with another datacenter. For example, a primary datacenter can include a primary database and a first set of application nodes. A secondary datacenter can include a secondary database and a second set of application nodes. The application nodes of the first and second sets can provide a service or application to remote clients, and can read or write data in the primary database. The secondary database can mirror changes made to the primary database and prevent write operations from being performed directly on the secondary database. In the event that a failover condition associated with the primary database is identified, the secondary database can operate as the primary database and can allow read or write access to data. The primary database can then operate as the secondary database, mirror the new primary database, and prevent direct write access to the new secondary database.

A distributed computing system can allocate resources of a computer network using a multi-tenant or single-tenant architecture, for example. Allocating resources in a multi-tenant architecture can include installations or instantiations of one or more servers, such as application servers, database servers, or any other server, or combination of servers, that can be shared amongst multiple customers. For example, a web server, such as a unitary Apache installation; an application server, such as a unitary Java Virtual Machine; or a single database server catalog, such as a unitary MySQL catalog, can handle requests from multiple customers. In some implementations of a multi-tenant architecture, the application server, the database server, or both can distinguish between and segregate data or other information of the various customers using the system.

In a single-tenant infrastructure (which can also be referred to as a multi-instance architecture), separate web servers, application servers, database servers, or combinations thereof can be provisioned for at least some customers or customer sub-units. Customers or customer sub-units can access one or more dedicated web servers, have transactions processed using one or more dedicated application servers, or have data stored in one or more dedicated database servers, catalogs, or both. Physical hardware servers can be shared such that multiple installations or instantiations of web servers, application servers, database servers, or combinations thereof can be installed on the same physical server. An installation can be allocated a portion of the physical server resources, such as RAM, storage, communications bandwidth, or processor cycles.

A customer instance can include multiple web server instances, multiple application server instances, multiple database server instances, or a combination thereof. The server instances can be physically located on different physical servers and can share resources of the different physical servers with other server instances associated with other customer instances. In a distributed computing system, multiple customer instances can be used concurrently. Other configurations or implementations of customer instances can also be used. The use of customer instances in a single-tenant architecture can provide, for example, true data isolation from other customer instances, advanced high availability to permit continued access to customer instances in the event of a failure, flexible upgrade schedules, an increased ability to customize the customer instance, or a combination thereof.

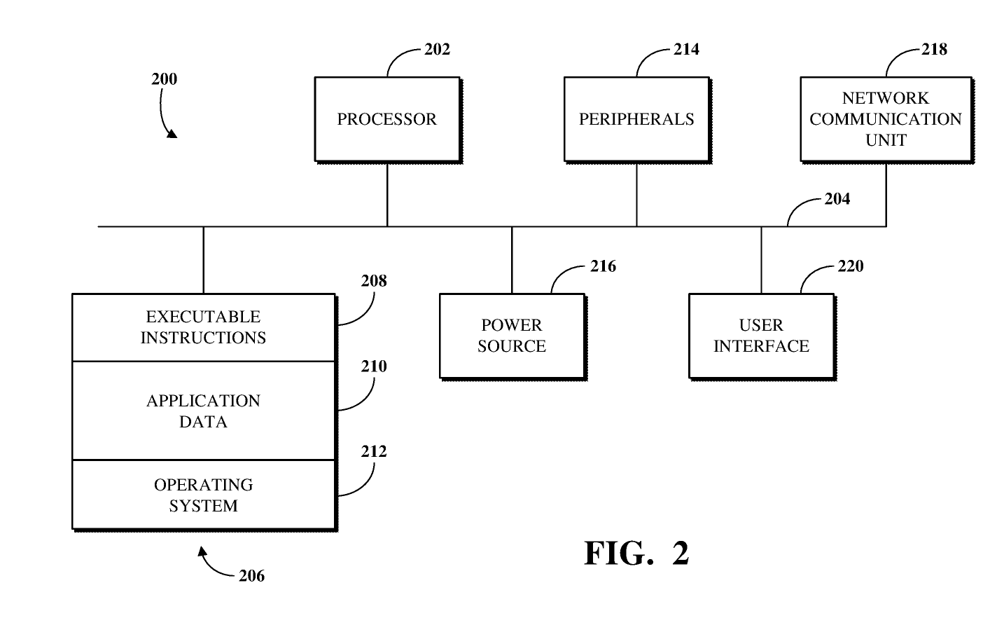

FIG. 2 is a block diagram of an example of an internal configuration of a computing device 200 of an electronic computing and communications system, such as a client 104 or a server, such as an application server 112 or a database server 116, of the system 100 shown in FIG. 1. As previously described, a client or server can be a computing system including multiple computing devices or a single computing device, such as a mobile phone, a tablet computer, a laptop computer, a notebook computer, a desktop computer, a server computer, or other suitable computing devices. A computing device 200 can include components or units, such as a processor 202, a bus 204, a memory 206, peripherals 214, a power source 216, a network communication unit 218, a user interface 220, other suitable components, or a combination thereof.

The processor 202 can be a central processing unit (CPU), such as a microprocessor, and can include single or multiple processors having single or multiple processing cores. Alternatively, the processor 202 can include another type of device, or multiple devices, now existing or hereafter developed, capable of manipulating or processing information. For example, the processor 202 can include multiple processors interconnected in any manner, including hardwired or networked, including wirelessly networked. In some implementations, the operations of the processor 202 can be distributed across multiple physical devices or units that can be coupled directly or across a local area or other suitable type of network. In some implementations, the processor 202 can include a cache, or cache memory, for local storage of operating data or instructions.

The memory 206 can include volatile memory, non-volatile memory, or a combination thereof. For example, the memory 206 can include volatile memory, such as one or more DRAM modules such as DDR SDRAM, and non-volatile memory, such as a disk drive, a solid state drive, flash memory, Phase-Change Memory (PCM), or any form of non-volatile memory capable of persistent electronic information storage, such as in the absence of an active power supply. The memory 206 can include another type of device, or multiple devices, now existing or hereafter developed, capable of storing data or instructions for processing by the processor 202. The processor 202 can access or manipulate data in the memory 206 via the bus 204. Although depicted here as a single bus, the bus 204 can be composed of multiple buses, which can be connected to one another through various bridges, controllers, or adapters.

Although shown as a single block in FIG. 2, the memory 206 can be implemented as multiple units. For example, a computing device 200 can include volatile memory, such as RAM, and persistent memory, such as a hard drive or other storage. The memory 206 can be distributed across multiple clients or servers, such as network-based memory or memory in multiple clients or servers performing the operations of clients or servers.

The memory 206 can include executable instructions 208, data, such as application data 210, an operating system 212, or a combination thereof, for immediate access by the processor 202. The executable instructions 208 can include, for example, one or more application programs, which can be loaded or copied, in whole or in part, from non-volatile memory to volatile memory to be executed by the processor 202. The executable instructions 208 can be organized into programmable modules or algorithms, functional programs, codes, code segments, or combinations thereof to perform various functions described herein. For example, the executable instructions 208 can include instructions to test elements of an instance of web application software using a plurality of windows of a web browser instance executing on a client, such as the client 104 shown in FIG. 1.

The application data 210 can include, for example, user files, database catalogs or dictionaries, configuration information or functional programs, such as a web browser, a web server, a database server, or a combination thereof. The operating system 212 can be, for example, Microsoft Windows®, Mac OS X®, or Linux®, an operating system for a small device, such as a smartphone or tablet device; or an operating system for a large device, such as a mainframe computer. The memory 206 can comprise one or more devices and can utilize one or more types of storage, such as solid state or magnetic storage.

The peripherals 214 can be coupled to the processor 202 via the bus 204. The peripherals can be sensors or detectors, or devices containing any number of sensors or detectors, which can monitor the computing device 200 itself or the environment around the computing device 200. For example, a computing device 200 can contain a geospatial location identification unit, such as a global positioning system (GPS) location unit. As another example, a computing device 200 can contain a temperature sensor for measuring temperatures of components of the computing device 200, such as the processor 202. Other sensors or detectors can be used with the computing device 200, as can be contemplated. In some implementations, a client or server can omit the peripherals 214. In some implementations, the power source 216 can be a battery, and the computing device 200 can operate independently of an external power distribution system. Any of the components of the computing device 200, such as the peripherals 214 or the power source 216, can communicate with the processor 202 via the bus 204.

The network communication unit 218 can also be coupled to the processor 202 via the bus 204. In some implementations, the network communication unit 218 can comprise one or more transceivers. The network communication unit 218 can, for example, provide a connection or link to a network, such as the network 106, via a network interface, which can be a wired network interface, such as Ethernet, or a wireless network interface. For example, the computing device 200 can communicate with other devices via the network communication unit 218 and the network interface using one or more network protocols, such as Ethernet, TCP, IP, power line communication (PLC), WiFi, infrared, GPRS, GSM, CDMA, or other suitable protocols.

A user interface 220 can include a display; a positional input device, such as a mouse, touchpad, touchscreen, or the like; a keyboard; or other suitable human or machine interface devices. The user interface 220 can be coupled to the processor 202 via the bus 204. Other interface devices that permit a user to program or otherwise use the computing device 200 can be provided in addition to or as an alternative to a display. In some implementations, the user interface 220 can include a display, which can be a liquid crystal display (LCD), a cathode-ray tube (CRT), a light emitting diode (LED) display (e.g., an OLED display), or other suitable display.

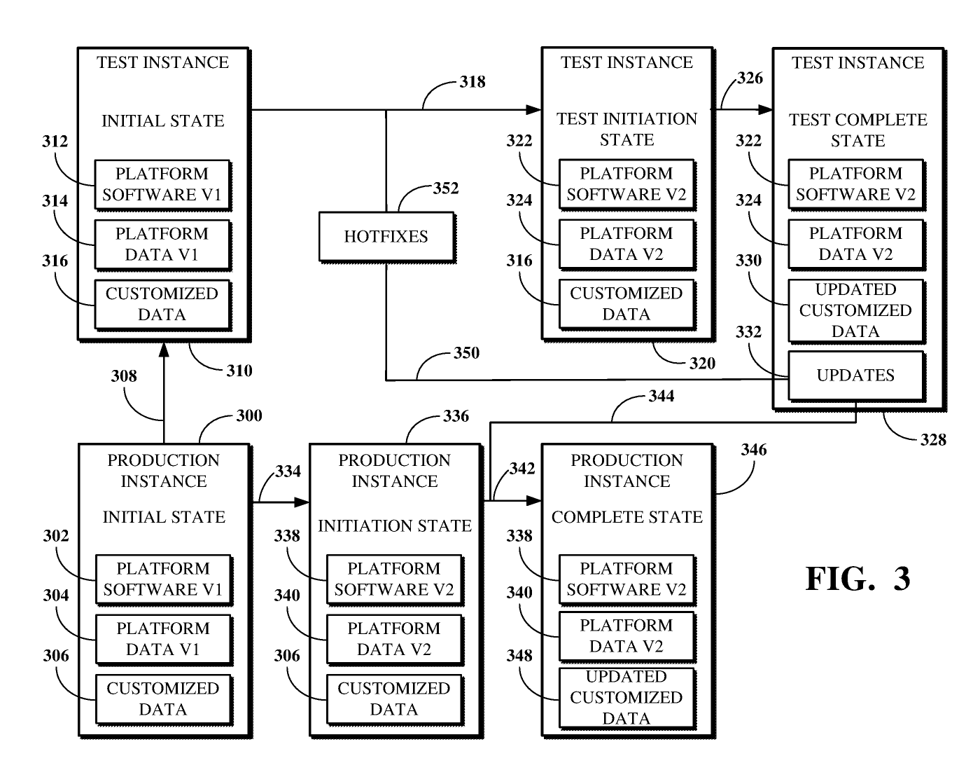

FIG. 3 is a block diagram of an example of states of a production instance and a test instance of platform software. The platform software can be implemented using executable instructions from by a PaaS service provider. The PaaS service provider can execute distinct instances of the platform software for respective customers, such that a customer can access its instance of the platform software by communicating with a server device executing the instance. In some implementations, an instance of platform software can be implemented using one or more application nodes and one or more database nodes, such as the application node 114 and database 118 shown in FIG. 1, wherein the application node 114 can implement a version of the platform software and the database 118 can store a version of platform data used by the version of the platform software and a version of user data created by a user of the instance.

An instance of platform software can be updated from time to time to add, remove, or otherwise modify the functionality thereof. Updating an instance of platform software can include upgrading a current version of the platform software to a newer version (e.g., updating version 2.0 to version 3.0), downgrading the current version to an earlier version (e.g., updating version 2.0 to version 1.0), applying a patch or a plugin to update portions of the platform software (e.g., updating version 2.0 to version 2.1), or the like. Updating an instance of platform software can also or instead include updating portions of the instance of platform software. For example, an instance of platform software can include core functionality and extensible functionality. For example, the platform software may by default include certain functionality and may have applications that may be installed or added to an instance of platform software. An update to the instance of platform software can therefore include updating the core functionality, the extensible functionality, platform plugins that add further application functionality, or the like, or combinations thereof.

An update to the instance of platform software can include reading or writing data, such as platform data, from or to the database accessible by the instance. For example, an update can be configured to leave user data unchanged, modify certain user data that may overlap with platform data, or combinations thereof. In implementations where user data is maintained (e.g., a modified platform data script) instead of updating the data with updated platform data (e.g., an update to the platform data script that was modified), errors in the operation of the platform software may be introduced.

Instructions for performing an update to an instance of platform software can include changes to be made to the database, such as to the structural elements thereof or values of the data stored in the fields thereof. For example, the update to the instance of platform software can include functionality not previously included in the underlying platform software (e.g., a pre-update version of the platform software), which functionality can be implemented by changing database schema of the database to alter the manner in which the platform data or user data used by the instance of platform software is stored in the database.

An instance of platform software can be classified as an environment that can, for example, be representative of how the instance is used or the state of the instance. For example, environments can include production environments (e.g., environments in which application software of a customer can be used by clients of the customer) or non-production environments (e.g., environments for a customer to develop or test application software), or the like. An instance of platform software can be classified in one or more environments. For example, a first instance of platform software might operate in a production environment (and therefore be referred to as a “production instance”), whereas a second instance of the platform software might instead operate in a non-production (e.g., test or development) environment (and therefore be referred to as a “non-production instance” or a form thereof, for example, a “test instance”). An instance of platform software at a given state can have a particular version of software and a particular set of data associated with it. The version of software can be executed on application nodes, such as the application node 114, and the set of data can be stored in a database, such as the database 118.

Results of an update applied to a test instance of a version of platform software can be used to update a production instance of that version of platform software. An initial state of the production instance 300 (e.g., a pre-update state) can include a first version of platform software 302, a first version of platform data 304 (e.g., data associated with or provided by the first version of platform software), and customized data 306, which can be provided for use and access by the clients of the customer. The initial state of the production instance 300 can be copied or reinstalled at 308 to produce a new instance of the platform software, test instance 310. The initial state of test instance 310 can include the first version of platform software 312 (which can, for example, be copied from production instance 300, be a new install of the first version of platform software, or combinations thereof), a copy of the first version of platform data 314 (which can, for example, be copied from platform data 304, be created by installing the platform software, or combinations thereof), and customized data 316 (which can, for example be copied from customized data 306). The update can be processed with respect to the first version of the platform software 312, the first version of platform data 314, and the customized data 316 of the test instance prior to applying that update to the first version of platform software 302, first version of platform data 304, and customized data 306 of the production instance.

The initial state of the test instance 310 might not be an exact copy or reinstallation of the initial state of the production instance 300, but can be substantially similar to the initial state of the production instance 300, for example, in its entirety, for portions of the initial state of the production instance 300 to be tested, or the like. The test instance can be implemented by a same computing device or a different computing device from that used to implement the production instance. The instructions for performing the update can be executed to apply the update to the initial state of the test instance 310 (e.g., to update the first version of the platform software 312, the first version of the platform data 314, and the customized data 316.

In some implementations, a development instance (not shown) that is another non-production instance can be used to generate the instructions for performing the update. For example, a customer of a PaaS service provider can initiate an update to platform software of the development instance. The development instance can be used, for example, to correct known functional impairments of the development instance created by the update. The development instance can then be copied as the test instance initial state 310. In this way, the development instance can be used to update the platform software and apply changes (e.g., to the customized data) to correct functional impairments before the test instance is tested, and the test instance can be used to test the development instance. The process can then repeat, such as by applying the updated customized data to the test instance to create a new test instance for testing the applied updates along with incremental change made to the development instance (e.g., by using hotfixes 352, such as described later). In this way, functional impairments caused by the update can be addressed in an iterative fashion before the updates to the platform software, the platform data, or the customized data are applied to the production instance. This can also have the benefit of keeping separate instances for making changes (e.g., to the platform software, platform data, and customized data) and for the testing process.

An update can be processed at 318 to produce a test initiation state of the test instance 320 by updating the platform software and platform data thereof. In some implementations, the update can be processed at 318 without updating customized data associated therewith. This is because the update to be processed is an update to the platform software, rather than an update to any customer configurations or customizations implemented in connection with the platform software. As such, the test initiation state of the test instance 320 can include a second version of the platform software 322, a second version of the platform data 324, and the customized data 316. The test initiation state of the test instance 320 in the initial case includes the original customized data 316 from the initial state of the test instance 310 or from a development instance. The test initiation state of the test instance 320 can also or instead receive updates generated using the hotfixes 352.

A test can then be performed at 326 with respect to the second version of the platform software 322, the second version of the platform data 324, and the customized data 316 of the test initiation state of the test instance 320. Because the update to the platform software and platform data of test instance at 318 might have caused changes to the function of the customized data 316 of the test instance, the test can be performed to identify functional impairments of the customized data 316 responsive to the update. More than one test can be performed at 326. Performing the test(s) at 326 produces a test complete state of the test instance 328 including of the platform software 322, the second version of the platform data 324, updated customized data 330 reflecting changes made to the customized data 316 based on the results of the test. The results of the test can be used to produce information for altering the platform software, the platform data, and/or the customized data, for example, using hotfixes 352, such as described later.

The updates 332, which can include the results of the test performed at 326, indicate changes to be made to the original form of the user data such that the platform software can continue operating using the platform data and the user data after the update is processed. Thus, components of the platform software instance (e.g., some or all of the user data) having impaired functionality caused by the update can be identified and recorded for later use in applying the update to the production instance of the platform software. Elements having impaired functionality can, for example, be altered such that they no longer cause impairments to the functionality of the first instance, or be skipped when committing the update to the first instance (e.g., to produce the updated customized data 330 based on the customized data 316). For example, where a first component of the platform data was updated by changing the variable type from an integer to a float, a first component of the user data that is calculated based on the first component of the platform data might not function properly because it is dependent upon the first component of the platform data being a whole number rather than a number having a decimal value. The updated customized data 330 can thus include a new version of the first component of the user data that is a float such that it can be calculated based on the float of the first component of the platform data without functional impairment. The updates 332 can include information indicating that the first component of the customized data 316 was changed from an integer to a float to resolve the functional impairment. Alternatively or in addition, other data that interacts with the elements of data having impaired functionality may be altered, for example, when the impairment is caused by a change in other data that the element depends on (e.g., such as when the element that fails is a script that calls a function or application programming interface provided by the other data that has been changed by the version update).

In some cases, the updates 332 (e.g., the results of the test performed at 326) can indicate that the platform software is not functioning as intended as of the test instance test complete state 328. In those cases, information about failures associated with the updates 332 can be used to develop further changes to the platform software, which may be referred to as “hotfixes” 352. The hotfixes 352 can be applied on top of or in place of previous updates to the platform software by returning to the test instance at 318 via path 350. The hotfixes 352 can also or instead come from a development instance (not shown), in which case the hotfixes 352 can be fed into path 318 to result in a new test instance test initiation state and a new test instance test complete state. For example, the updates 332 can be us used to identify aspects of the platform software to be further updated using the hotfixes 352. Applying the hotfixes 352 at the test instance test initiation state 320 can result in a different set of updates 332 at the test instance test complete state 328.

At 334, the same update as was applied to the initial state of the test instance 310 (e.g., to produce the test initiation state of the test instance 320), or a substantially similar update, can be applied to the first version of platform software 302, the first version of platform data 304, and the customized data 306 of the initial state of the production instance 300 to produce an initiation state of the production instance 336. Operation 334 can be completed in parallel with operations 318 and/or 326, or can be completed after testing has completed. The initiation state of the production instance 336 can include a second version of the platform software 338, a second version of the platform data 340 and the customized data 306. The second version of the platform software 338 and the second version of the platform data 340 can respectively be the same or substantially similar to the second version of the platform software 322 and the second version of the platform data 324 of the test initiation state of the test instance 320. As the update applied to the initial state of the production instance 300 at 334 is an update to the platform software and the platform data, the customized data 306 of the initiation state of the production instance 336 can be the same or substantially the same as the customized data 306 of the initial state of the production instance 300.

At 342, the updates 332 applied to the customized data 316 to produce the updated customized data 330 in the test instance can be applied to the initiation state of the production instance 336 to produce the complete state of the production instance 346. Namely, the updates 332 can be applied to the customized data 306 to produce the updated customized data 348. Updating the customized data 306 using the updates 332 can eliminate or reduce the number of functional impairments of the customized data 306 resulting from the update to the platform software and the platform data at the initiation state of the production instance 336. For example, the expected functional impairments to the customized data 306 can be identified during the update processed with respect to the test instance, as described above. In this way, those expected functional impairments can be resolved in whole or in part using the updates 332 used to address and resolve corresponding functional impairments to the customized data 306 caused by the update to the platform software and platform data of the initiation state of the production instance 336.

FIG. 3 is an example of states of a process for updating and testing instances of platform software. Some or all of the states shown may be included in a single process and may exist for a short period of time during such a process. For example, states 310, 320, and 328 may be a part of a single process which may include limited or no user interaction. For example, when the test instance is created at 310, it is automatically updated to state 320, and then testing and updates are completed to state 328 (e.g., with minimal or no user interaction).

Implementations of the instances of web application software shown in FIG. 3 can include additional, less, combined, or other functionality, or a combination thereof, different from those described above. For example, and although implementations for updating an instance of web application software shown in FIG. 3 describe performing a test prior to updating the instance, tests can also or instead be performed after an update has been applied to the instance of platform software, such as to test a behavior of the instance of platform software responsive to the update. For example, after the updates 332 are applied to the production instance to result in the production instance complete state 346, the platform software v2 338, the platform data v2 340, and the updated customized data 348 can be used as a new initial state of the production instance for re-testing through path 308. For example, a user of the instance of web application software may at some time after the update has been applied determine that the update caused a regression to certain functionality of the instance of web application software. The user may begin a subsequent update process to re-test the instance of web application software to determine the issue.

In some implementations, the web application software can be application software developed by a customer of a PaaS service provider based on platform software of the PaaS service provider. In some implementations, the application software can execute on a same application server 112 executing the platform software at a datacenter 108. In some implementations, the application software can execute on a server not controlled by a PaaS service provider. The application software can be controlled by the customer and accessed by clients of the customer over a computer network.

The update to the application software can be derived from groups of customizations that can be moved from one instance of the application software to another and committed by the customer. For example, the groups of customizations can include alterations to be made to a database accessible by the application software, such as changes to the structural elements of the database or the data stored in the fields thereof. In some implementations, the groups of customizations can be communicated to and applied by the PaaS service provider to facilitate the update to the application software.

The web application software can be application software developed independently of a PaaS cloud computing environment. The application software can include instructions executable on a local computing device (e.g., using an operating system of the local computing device), by web browser software, or other modules, systems, platforms, or devices. For example, the application software can be software for processing documents, altering multimedia materials, managing accounting data, or another type of software. In some implementations, the application software can be software used for a database management system, such as an RDBMS. In some implementations, the application software can be or be used to operate software included within a Software-as-a-Service (SaaS) cloud computing environment.

The web application software can be system software used to control devices that perform database operations. For example, the system software can include an operating system implemented on a database server (e.g., the database server 116 shown in FIG. 1), wherein an update to the web application software can include updating a database operating on the database server device and accessible by the operating system. In some implementations, the system software can be software used to operate infrastructure included within an Infrastructure-as-a-Service (IaaS) cloud computing environment.

The database 118 can be a relational database including tables and the like for logically relating records (e.g., rows of the tables) to attributes (e.g., columns of the tables). In some implementations, the database 118 can be a non-relational database, such as an object database including fields of objects programmatically included within corresponding software and pointers for linking objects. In some implementations, the database 118 can be a document database including stores for document objects (e.g., XML files, JavaScript Object Notation (JSON) files, or the like). The database 118 can be another type or combination of types of database suitable for storing data accessible by the application node 114.

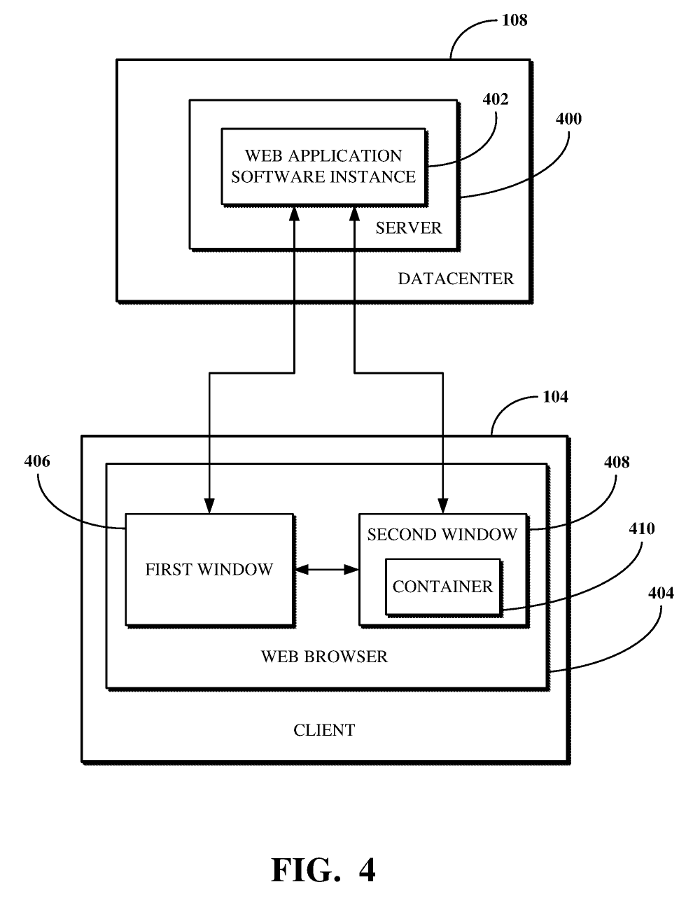

FIG. 4 is a block diagram of an example of client-server communications for testing behavior of an instance of web application software. The client 104 can be the client 104 shown in FIG. 1. The server 400 can be the application server 112 shown in FIG. 1, the database server 116 shown in FIG. 1, a physical server device operating one or both of the application server 112 or the database server 116, or the like or a combination thereof. The server 400 operates at a datacenter 108, such as the datacenter 108 shown in FIG. 1, whereas the client 104 can operate external to the datacenter 108.

The server 400 operates an instance of web application software 402, which can be an instance of web application software described in FIG. 3 as including an application node 114 and a database 118. In some implementations, an instance of web application software 402 can be implemented using one or more application nodes, one or more database nodes, or a combination thereof. In some implementations, the application nodes or database nodes can be located on the same server 400, different servers within the same datacenter 108, or different servers within different datacenters. The client 104 can communicate with the instance of web application software 402 using a web browser 404 executing on the client 104. The web browser 404 can be or include software for processing requests to access webpages, receiving requests from sources external to the client 104 to access data of the client 104, or performing other actions in connection with communicating information between the client 104 and another computing device. The web browser 404 can include one or more windows, wherein a window of the web browser 404 is configured to process a webpage therein using system resources of the client 104, such as memory or processor cycles of the client 104. In some web browser implementations, some or all of the windows of the web browser can each be allocated a certain amount of system resources. For example, the sum of system resources allocated to two windows may be greater than the system resources available to a single window. As used herein, the term “window” can refer to a window, tab, document, panel, or other graphical element and associated processing functionality, such as an instance of an HTML interpreter, a JavaScript interpreter, or the like, usable to control the processing of a web page or similar information within the web browser 404, or the like.

The instance of web application software 402 can be implemented as a webpage processed by a first window 406 of the web browser 404. For example, where the web application software is platform software operated in a PaaS environment, a user of the client 104 can access a web page of the platform software for entering login credentials (e.g., a username and password configuration) for accessing the platform software within the first window 406 of the web browser 404. A request can be sent from the client to the platform software after the login credentials are verified. The platform software responds to the request by sending a webpage to the first window 406 of the web browser 404, which webpage can include instructions in one or more structured languages interpretable by the web browser 404, for example, HTML, JavaScript, CSS, or the like.

Amongst other things, the instance of platform software can include instructions or the capability to generate instructions for testing behavior of one or more, or all, components of the instance of platform software using the web browser 404. In some implementations, a webpage of the instance of platform software including options to configure a test of the instance of platform software can be sent to the client. The test can be used to test the behavior of the instance of platform software. The test can be performed in view of identifying updates that need to be made to data of the platform instance, for example, as described in FIG. 3. However, the test can also be performed independently of an update to be made to the platform instance or other software, for example, to determine whether the platform instance or other software is functioning as intended. Configuring the test can include defining steps of the test, for example, by selecting a component of the instance of platform software to be tested, indicating a value or other data to be asserted within the user interface element, and validating that value or other data. In some implementations, the test can be configured without the user directly writing or modifying scripts or other program instructions to be executed by the instance of platform software. In some implementations, the test can be configured using a combination of defining steps of the test and extending the definitions of those steps using scripts or other program instructions. In some implementations, tests can already be defined, such as within the platform software as shipped, by a user at a prior time, or combinations thereof. In some implementations, tests can be grouped together. In some of the foregoing implementations, a user can select the previously defined tests, groups, or combinations thereof.

The components of the instance of platform software that can be tested may include those that use platform data, user data, or a combination thereof. The data used by components can be represented as records of a database accessible by the instance of platform software, which records can be displayed in a webpage using user interface elements, such as forms for interfacing between a graphical user interface of the instance of platform software and fields corresponding to the platform data or user data stored in the database. A form can relate to a record of the database, for example, a row of a table within a relational database or an XML document within a document database. As such, fields of the form can correspond to fields of the database record. A test can thus be configured by the user of the client 104 selecting a form (or a database record corresponding to the form) and asserting and validating values for the respective fields of the form, for example, using a graphical user interface of a webpage used to configure the test. In some implementations, a list of fields of the form and corresponding input fields can be included in the graphical user interface displayed within the web browser 404 such that the user of the client 104 can configure the test without viewing the actual layout of the form.

The types of input fields included in the graphical user interface for configuring a step of a test can depend upon the types of fields within the form. For example, when configuring a test step to assert values against a form having a date field and a username field, the corresponding graphical user interface can include an input field that prompts a user to select a date from a calendar for the date field and one of a drop down list for selecting the username for the username field from a list of known usernames or an input box for the user to type a username. In this way, the instance of platform software can prevent values from being asserted against fields that do not exist. In other tests, the graphical user interface can be manipulated in such a way to trigger execution of scripts included in the platform and/or user data. Depending on the implementation, other types of tests may be available through interaction with the graphical user interface, document object model (DOM), scripts, or other aspects of the web page.

The test can include server-side operations for preparing steps of the test for performance. For example, a test can include data setup elements, data cleanup elements, or the like to prepare data associated with a next test step (e.g., determining that the next test step is applicable, such as by validating that a database table or other data structure including the respective data is accessible by the second window performing the test). The instance of web application software can determine server-side operations to be performed based on the steps of a test to perform, for example, by identifying the components of the instance of web application software that will be under test.

The test can be performed once its configuration has been completed. For example, the test can be performed on-demand by a user of the client 104 causing a command to be sent to the server 400 to perform the test. For example, the user of the client 104 can interact with a submission button or like user interface element to send a request to the server 400 to perform the test from a webpage on which the test is configured. In another example, the user of the client 104 can select the test from a list of tests configured for the instance of platform software. Alternatively, the test can be performed automatically, such as according to a schedule for the test previously defined, for example, by a user of the instance of platform software who configured the test.

The test can be performed in a second window 408 of the client 104. The server 400 can cause the second window 408 to be opened for performing the test if it is not already open. For example, the server 400 can send instructions to the client 104 that, when processed by the first window 406, cause the web browser 404 to open a second window 408, such as by using a native application programming interface (API) of the web browser 404. In another example, the server 400 can send instructions to the web browser 404 to prompt a user of the client 104 to manually open the second window 408, such as by using a hyperlink transmitted by the server 400.

In the event that a plurality of second windows are open, a user of the client 104 can select a second window to use for performing a test from a list of second windows (e.g., sent to the client 104 by the server 400). Information about respective second windows can be indicated by the list of second windows. For example, for a given second window, the list can indicate a web browser on which the second window is open, an operating system executing that web browser, and/or information usable for identifying the host machine on which the second window is open (e.g., an IP address, domain name, session cookie, etc.).

In some implementations, a list of second windows can be limited to second windows opened by a particular user (e.g., of one or more clients, such as the client 104). When multiple users of the instance of web application software 402 access the instance of web application software 402 simultaneously, each user can open a first window 406 and one or more second windows 408 exclusive to that user (e.g., based on user account). For example, if a first user opens two second windows using a client and a second user opens three second windows using the same or a different client, the two second windows opened by the first user will be included in the list of second windows when the first user accesses the instance of web application software 402. Furthermore, where a test is automatically performed (e.g., according to a schedule), the second windows opened by the user who configured the automatic performance can be included in the list of second windows available for automatically performing the test.

The second window 408 can retrieve a second webpage including a container 410 in which the test can be performed. The container 410 can include inline frame elements (e.g., HTML IFrame) for embedding webpages associated with components under test within the second window 408. After the second window 408 has been opened, the server can send instructions to the client 104 for the test to be performed within webpages embedded within the container 410 within the second window 408. In some implementations, the container 410 in the second window 408 can retrieve a plurality of webpages wherein respective ones of those webpages correspond to components to be tested in connection with the test and are serially retrieved by the container 410 in the second window 408 according to an order in which the components are to be tested. In this case, the instructions received from the server 400 to perform the test within the second window 408 can include instructions to process different webpages within the container 410 of the second window 408.

The instructions received from the server 400 to perform the test can be sent at a single time (e.g., before performance of the test has been initiated) or at various times (e.g., wherein instructions are received in serial based on the component to be tested or webpage to be processed in the second window 408 at a given point of the test). In some implementations, the second window 408 can receive the instructions for performing the test from the server 400 over a communication channel. For example, an asynchronous message bus (AMB) channel can be implemented between the server 400 and the client 104 such that the server 400 can send messages over the AMB channel for processing within windows of the web browser 404 on the client 104. An AMB channel can be configured to permit the server 400 to send a message to the client 104 without waiting for the client 104 to send a request to the server 400. An AMB channel can be implemented using, for example, HTTP long-polling, HTTP WebSockets, or the like.

The tests performed in the second window 408 can be controlled at least in part by the server without using the first window. For example, where the test is performed on-demand, the instructions received from the first window 406 can include instructions for causing the second window 408 to listen to the server 400 for performing the test. In another example, where the performance of the test is automated, the server 400 can control the performance of the test within the second window 408 without first receiving instructions from the first window 406. For example, the second window 408 can listen to an AMB channel for instructions sent by the server 400 to use system resources of the client 104 allocated to the second window 408 to perform various steps or like elements of the test. Responsive to completing a performance of such steps or like elements, the second window 408 can listen to the AMB channel for further instructions to be sent by the server 400 to use other system resources of the client 104 allocated to the second window 408 to perform further steps or like elements of the test.

There can be a number first windows or second windows 408 operating within one or more web browsers 408, which one or more web browsers 408 can execute on one or more clients 104. A single first window 406 can be used to request that ones of a plurality of tests be performed in ones of a plurality of second windows 408. Alternatively, during automated testing, there may be no first windows and a plurality of second windows for performing respective ones of a plurality of tests. For example, a plurality of second windows can be used for compatibility testing of a component of an instance of web application software in various environments (e.g., within different web browsers, on different clients, or the like, or combinations thereof).

Further, a number of first windows or second windows can operate within a plurality of web browsers. For example, a first web browser can include one first window and ten second windows, a second web browser can include no first windows and thirty second windows, and a third web browser can include fifteen first windows and fifteen second windows. The first, second, and third web browsers can execute on the same client or different clients. For example, the first and second web browsers can execute on a first client while the third web browser executes on a second client. Further a first window that requests the performance of a test within a second window does not have to operate in the same web browser as that second window. For example, the first window can operate in a first web browser and the second window can operate in a second web browser. The request sent from the first window to the server can then be used to perform a test within the second window of the second web browser.

Changes made to values of database fields accessible by the instance of platform software caused by the performance of the test can be stored as records in a table of the database accessible by the instance of platform software (e.g., the database 118), a table of another database, another data structure, a JSON document, or the like or a combination thereof. The changes made to values of database fields during a given step of a test can be sent from the client 104 (e.g., from the second window 408) to the instance of platform software after that step of the test has been completed. In this way, records indicative of the changes can be stored based on the completion of individual test steps, rather than waiting for the entire test to be completed. For example, performing a first step of a test may result in changes to one hundred database field values, performing a second step may result in no changes to any database field values, and performing a third step may result in a change to a single database field value. The results respectively sent to the instance of platform software after the first, second, and third steps would thus cause one hundred records to be stored within the database (or data structure or the like, as the case may be), no records to be stored, and one record to be stored. Once the entire test has been completed, the records stored after the individual test steps completed can be deleted or reverted to their respective pre-test configurations to reflect corresponding pre-test values of respective database fields.

Metadata can be sent with the results of individual test steps from the client 104 to the server 400 to distinguish between results of test steps to be deleted or reverted after an entire test has been completed and other records of the instance of platform software. For example, the second window 408 can request that the container 410 retrieve a particular webpage from the server 400 for performing a test step or set of test steps. In addition to sending instructions for the webpage, the server 400 can send additional instructions (e.g., additional HTML code) that, for example, includes instructions for the second window 408 to send metadata indicating that the results of the test step (or set of test steps) are to be deleted or reverted once the entire test has been completed. The additional instructions can leverage a native API of the web browser 404 so that the metadata for distinguishing between test step results to delete or revert and other records can be associated with various requests transmitted between the web browser 404 and the server 400.

The additional instructions can also include a request for log data reported by a console aspect of the web browser 404 (as described later). The additional instructions can distinguish between errors reported due to a failure associated with a configuration and/or performance of a test and errors reported due to other failures of the instance of web application software 402. The additional instructions can also or instead include instructions for sending metadata indicating to delete or revert corresponding test step result data where the test step includes sending asynchronous JavaScript from the client 104 to the server 400 or from the server 400 to the client 104. The metadata usable for indicating results of tests steps to be deleted or reverted can include an HTTP header, a parameter that can be added to a URL sent between the client 104 and the server 400, or the like.

In some implementations, some or all of the records can be committed to the instance of platform software after the performance of the test has been completed in order to update the instance of the platform software from a first software version to a second software version. In some implementations, records created during a test can be removed from the table or other data structure in which they are stored during the performance of the test upon the completion thereof. In this way, unused data can be rolled back so as to not affect subsequent tests, to prepare storage space for records indicating successes or failures for a subsequent test, or combinations thereof.

The web browser 404 includes a console aspect (e.g., a graphical user interface rendered by a window of the web browser 404, a native extension to the web browser 404, or combinations thereof) for logging errors or other messages associated with processing webpages within windows of the web browser 404. The errors or other messages logged using the console aspect of the web browser 404 can indicate failures of components under test identified during a performance of the test. For example, some or all of the errors or other messages logged using the console aspect while a given step of a test is being performed can be reported by the web browser 404 (e.g., using a listener aspect that the instance of platform software 402 causes to run within the web browser 404) along with results of the step once that step has been completed. The listener aspect can determine whether failures indicated by the imported data are associated with the manner in which a test is configured (e.g., where the test includes asserting values against database fields that do not exist) or a form affected by the performance of a test step (e.g., where an asserted is not of the same variable type as the database field against which it is asserted). In this way, a user of the client 104 can review relevant errors reported or messages logged using the console aspect of the web browser 404 to troubleshoot failures of the test.

In some implementations, performing a test step can include generating an image representing the form under test. For example, the image can show how the form appears when the test is performed, such as including new fields, excluding previous fields, rearranging fields between sections of the form, changing a header of the form, or otherwise changing the layout of the form. In this way, images generated for test steps can be used to troubleshoot failures of a test, for example, by indicating that information within a form changed, that a form was not submitted for the test, that a validation failed, or the like. The images can be generated by the instance of platform software 402 using metadata associated with a webpage retrieved within the container 410, which metadata can indicate frames, text, and other aesthetic elements of the webpage. In some implementations, the images can be generated using screenshot software executing in connection with the web browser 404.

Implementations of the system depicted in FIG. 4 can include additional modules, fewer modules, combined modules, modules with additional or less functionality than those described above, or combinations thereof. In some implementations, the server 400 can include functionality for determining that a testing conflict exists with respect to an instance of web application software. For example, where a first test is being performed for an instance of web application software, the server 400 can prevent the performance of a second test from starting until after the first test is completed. In another example, where a component is to be tested in connection with a test, a module or like set of instructions executing on the server can determine whether that component is then-currently under a separate test (e.g., by a request received from a different client). In the event that that component is then-currently under a separate test, a testing conflict can be determined with respect to that component. The server can then delay processing instructions associated with the later test until after the testing conflict is resolved (e.g., by the test associated with the request received from the different client being completed).

In some implementations, the web browser 404 can be executed on a hardware or software component other than a client 104. For example, the web browser 404 can be implemented on an agent device within a customer environment, which agent device can be used to control communications of data between hardware or software components under the control of a customer (e.g., the customer 102 shown in FIG. 1) and hardware or software components under the control of a PaaS service provider or other service provider. In another example, the web browser 404 can be implemented on a computing device of the customer environment or a virtual machine instantiated within the customer environment, which virtual machine can be operated on a computing device within the customer environment, a third-party environment (e.g., that of a cloud computing service provider), or the like or a combination thereof. In another example, where the web application software is platform software operated by a PaaS service provider, the instance of platform software can orchestrate the provisioning of the web browser 404 on a computing device or virtual machine within a customer environment using agent software configured to permit communication between the provider and customer environments (e.g., by initiating a connection from within the customer environment to a provider environment, such as by using an HTTP protocol permitted by a firewall of the customer environment). That is, the agent software associated with the instance of platform software can provision the execution of one or more web browsers on one or more machines (e.g., devices, virtual machines, or combinations thereof).

In some implementations, the first webpage processed within the first window 406 can include a list of tests that are in progress or pending. One particular test of the list, for example, may be performed using the second webpage of the second window 408. A user of the client 104 can navigate away from the first webpage within the first window 406 which the particular test is being performed, such as by directing the first window 406 to process a different webpage. The user of the client 104 can thereafter return to the first webpage and select to continue monitoring the progress of the particular test, such as by selecting the particular test from the list of tests that are in progress or pending.

In some implementations, one or both of the first webpage or the second webpage can include a progress bar for indicating a percentage of the test that has been completed at a given time. For example, the second webpage can include a progress bar that updates after the completion of each test step (e.g., upon or at a time proximate to the sending of results of a test step to the server 400). In another example, the first webpage can include a progress bar that updates after receiving information about completed test steps from the server 400. The percentage by which the progress bar updates after a given step can be based on the total number of steps (in which case the progress bar increases may be equal), the total number of database field values changed by steps of the test (in which case the progress bar increases may not be equal), or the like.

The output produced from performing a first test step can later be used as input for performing a second test step. The results of a test step can be transmitted to the server 400 and stored in a common database table, store, or other data structure with results of other test steps. When a given test step is being performed, or at a time proximate to the performance thereof, the second window performing the test can request that the server send appropriate output from a previously performed test step to be used as input for the given test step. The server can determine the data to use as the input for the given test step based on the context of the given test step.

In some implementations, the server can identify a variable type of the input to be used for the given test step based on the variable types of the fields associated with that test step. For example, where the given test step includes a form having a field for an incident ID, the server can transmit the output from a previous test step including an incident ID as the input to the given test step. Similarly, test step output including an integer would not be transmitted as input for the given test step since the variable types would not match. In some implementations, the server can identify the input to be used for the given test step based on the relation between the given test step and the test step immediately preceding the given test step. For example, a first test step can include adding a new user to an instance of web application software and a second test step can include validating a user's access to a form of the instance of web application software. The server can send the output of the first test step as input for the second test step by virtue of the fact that the first and second test steps both pertain to identifying users of the instance of web application software.

The inputs to be used for steps of a test can be validated when the test is configured. For example, a user of the client 104 can configure a test to validate a user's access to a form of the instance of web application software 402. The first step can include adding a new user to the instance of web application software. The second step can include opening the form using privileges of the new user. The third step can include setting a value for an integer field of the form, and the fourth step can include asserting that value against the integer field of the form. The instance of web application software 402 can determine that the input for the second step is information about a user and that the first step includes adding a new user. Similarly, the instance of web application software 402 can determine that the input for the fourth step is an integer value set in the third step. However, if the user of the client 104 configures the fourth step to assert a value other than for the integer field set in the third step, the instance of web application software 402 can determine that the input required for performing the fourth step would not be available. The instance of web application software 402 can notify the user of client 104 when the input required for a step of the test would not be available, such as by generating a prompt to appear within the first webpage on which the test is being configured.

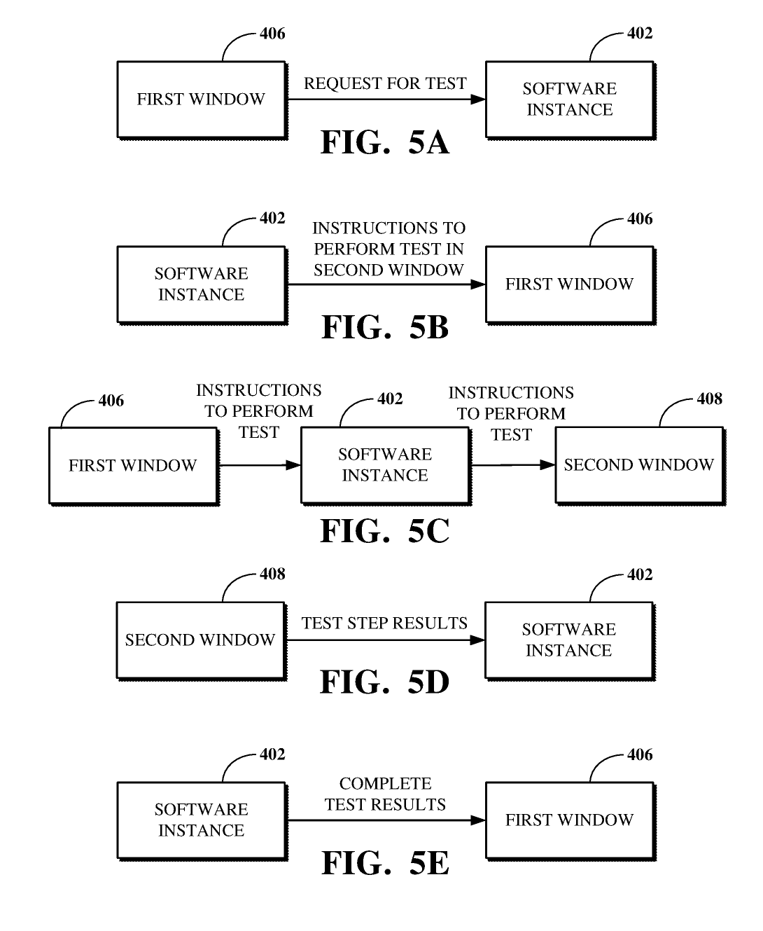

FIGS. 5A-E are block diagrams of examples of requests, instructions, or other data communicated in connection with testing behavior of an instance of web application software. In FIG. 5A, a request for a test of an instance of web application software is sent from a first window 406 of a web browser 404 to the instance of web application software 402. The request can include a command to initiate a test previously configured by the user. In FIG. 5B, instructions to perform a test in a second window 408 of the web browser 404 are sent from the instance of the web application software 402 to the first window 406 of the web browser 404. The first window 406 can process the instructions using instrumentation of the web browser 404 for receiving script or other program instructions, which instrumentation can process the instructions from the first window 406 to open the second window 408.

In FIG. 5C, instructions to perform the test are sent from the first window 406 to the second window 408 to perform the test. The instructions for performing the test are initially received from the instance of web application software 402, which can communicate the instructions at a single time or at various times during the performance of the test to the second window 408 through the software instance 402. In FIG. 5D, results of steps of the test are sent from the second window 408 to the software instance 402. The results of the test steps can include data (e.g., generated by the second window 408 or the instance of web application software 402) indicating successes or failures of the tested components of the instance of web application software. In FIG. 5E, the results of the test are sent from the software instance 402 to the first window 406 such that a user (e.g., of the client 104 of FIG. 4) can review the full results of the test.

While FIGS. 5A-E generally depict an implementation of communications within an electronic communications and computing system, such as the system 100 shown in FIG. 1, for testing behavior of an instance of web application software, other implementations for testing behavior of an instance of web application software in accordance with this disclosure can include additional, less, combined, or otherwise different functionality, or a combination thereof.

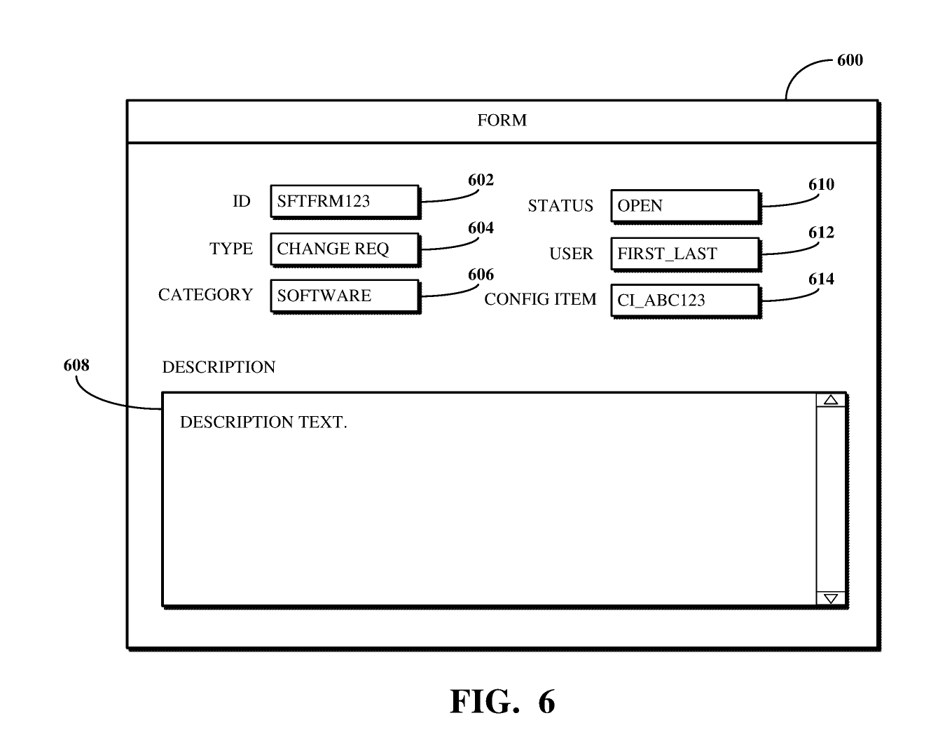

FIG. 6 is an illustration of an example of a graphical user interface 600 showing a component of an instance of web application software. The graphical user interface 600 can be viewed in a window of a web browser, for example, the first window 406 of the web browser 404 shown in FIG. 4. In the implementation shown in FIG. 6, the component of the graphical user interface 600 is a form of an instance of platform software; however, the component can be other components that use data stored in a database accessible by an instance of web application software. For example, the component can be a how-to article for troubleshooting connections within a computer network, a catalog of computer accessories that can be purchased from an online store, a software development portal for tracking progress between development teams, or the like.

The graphical user interface 600 can include a number of fields referencing data stored in a database accessible by the instance of platform software. For example, the form shown in the graphical user interface 600 includes an ID field 602, a type field 604, a category field 606, and a description field 608. In some implementations, additional fields can be included within a component of an instance of web application software based on data stored in other fields thereof. For example, because the value of the type field 604 is “CHANGE REQ,” indicating that the form corresponds to a change request to be processed, additional fields associated with change requests can be included in the form, such as a status field 610, a user field 612, and a configuration item field 614.

The form shown in the graphical user interface 600 can be stored as an entry within a database accessible by the instance of the platform software, for example, the database 118 shown in FIG. 1. For example, a table including the entry for the form in the database 118 can include columns for the fields 602, 604, 606, 608, 610, 612, or 614. The values of the data of those fields can be retrieved by querying the database 118 therefor. Those values can also be changed based on instructions for updating the instance of the platform software.

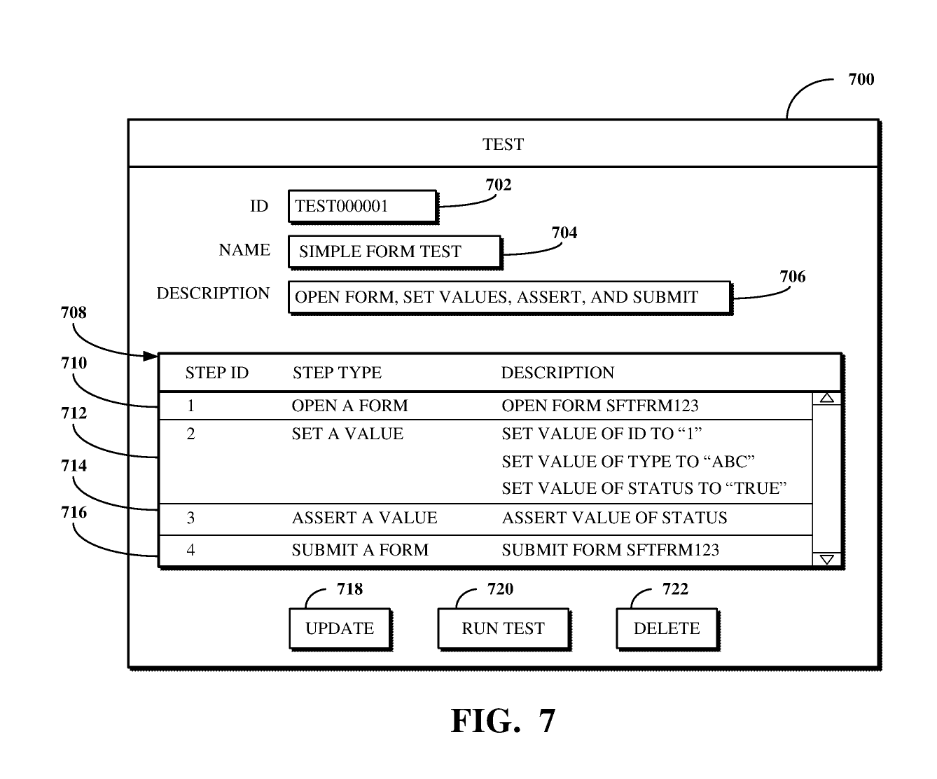

FIG. 7 is an illustration of an example of a graphical user interface 700 of a dashboard for configuring and performing tests for testing behavior of an instance of web application software. The graphical user interface 700 can be viewed in a window of a web browser, for example, the first window 406 of the web browser 404 shown in FIG. 4. The graphical user interface 700 can include fields for information that can be used to identify the test being configured. In some implementations, the graphical user interface 700 can include an ID field 702, a name field 704, and a description field 706. The graphical user interface 700 can also include a list of test steps 708 that have been configured for the test. The list of test steps 708 can include various steps 710, 712, 714, or 716 for selecting components to be tested (e.g., by opening a form), setting values for fields of the components based on changes made thereto by an update (e.g., for which the test can be modeled), asserting those values to test a success or failure of the component (e.g., by determining whether the updated value is incompatible with the field), or submitting a component to be tested (e.g., to store the updated values within a database).

For example, the test steps configured using the dashboard shown in FIG. 7 include opening a form having an ID of “SFTFRM123” (e.g., the component shown in the graphical user interface 600 of FIG. 6), setting a value of the ID field 602 to be “1,” setting a value of the type field 604 to be “ABC,” setting a value of the status field 610 to be “TRUE,” asserting the new value of the status field 610, and submitting the form.

The graphical user interface 700 can include user interface elements for sending commands to process the test configured therein. For example, the graphical user interface 700 can include an update button 718 to confirm changes made to the test within the dashboard, a run test button 720 to perform the test (e.g., sending a request to the instance of platform software to perform a test, which, in some implementations, responsively includes receiving instructions to perform the test in a newly opened second window of the web browser), and a delete button 722 to delete steps or the entire test from the instance of platform software.

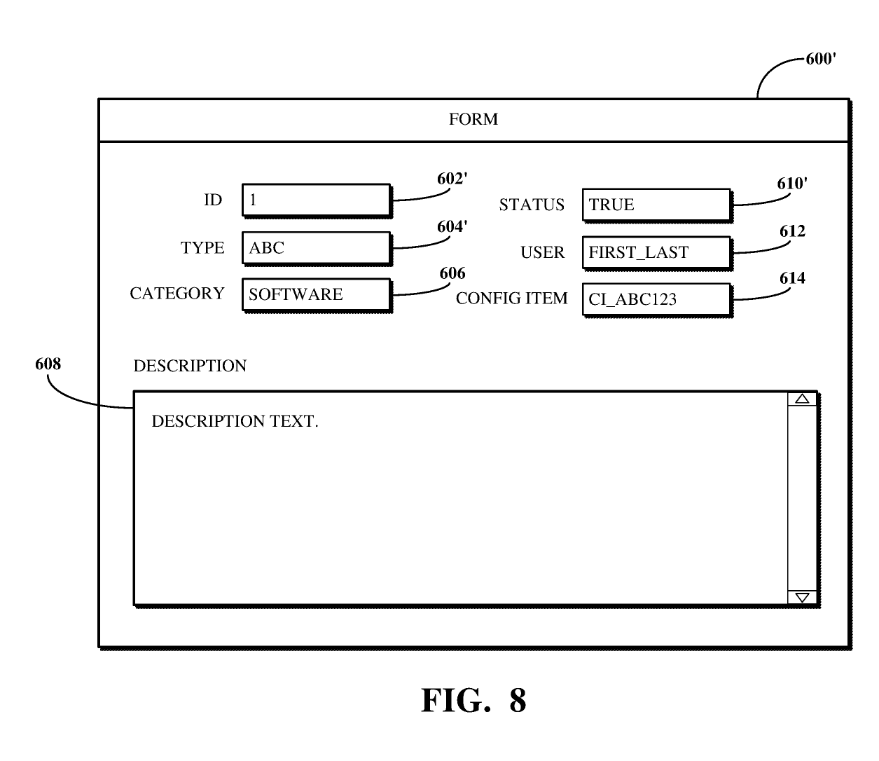

FIG. 8 is an illustration of an example of a graphical user interface 600′ showing the component of the instance of web application software of FIG. 6 updated responsive to a test performed against it. The graphical user interface 800 can be viewed in a window of a web browser, for example, the second window 408 of the web browser 404 shown in FIG. 4. Responsive to performing the test shown in FIG. 7, certain values of the component shown in FIG. 6 can change to new values. For example, the values for the category field 606, the description field 608, the user field 612, and the configuration item field 614 can remain unchanged because the test did not include setting or asserting new values against those fields. However, per the other test steps, the value for the ID of the component has changed from “SFTFRM123” in field 602 to “1” in field 602′. The value for the type of the component has changed from “CHANGE REQ” in field 604 to “ABC” in field 604′. The value for the status of the component has changed from “OPEN” in field 610 to “TRUE” in field 610′.

While some new values set or asserted in a test might not affect the functionality of the respective component, others of those values might cause functional impairments or other issues for the component. For example, the new value of the form ID “1” can generally be an acceptable ID for forms in the instance of platform software; however, if the instance of platform software indicates that the ID of a form is to include letters and numbers, setting the value of the form ID to “1” can result in a failure of the component. In another example, the new value of the form type “ABC” might result in a failure of the component where “ABC” is not recognized as a valid type of form. In another example, the variable type of the status field has been changed from a character string to a Boolean expression, which might or might not be acceptable based on how the database accessible by the instance of platform software stores data for the status field. In another example, the changing of a form element may cause platform software to execute a script that no longer functions as expected with interpreted by a new version of platform software (e.g., due to a change in APIs provided by the new version, due to a change in configurations or scripts provided by the platform software relied upon by the executed script, or the like).

One or more of the graphical user interfaces 600, 700, or 800, or other implementations of graphical user interfaces contemplated by this disclosure, can comprise part of a software graphical user interface constituting data that reflect information ultimately destined for display on a hardware device, such as a client 104. For example, the data can contain rendering instructions for bounded graphical display regions, such as windows, or pixel information representative of controls, such as buttons and drop-down menus. The rendering instructions can, for example, be in the form of HTML, SGML, JavaScript, Jelly, AngularJS, or other text or binary instructions for generating a graphical user interface on a display that can be used to generate pixel information. A structured data output of one device can be provided to an input of the hardware display so that the elements provided on the hardware display screen represent the underlying structure of the output data.

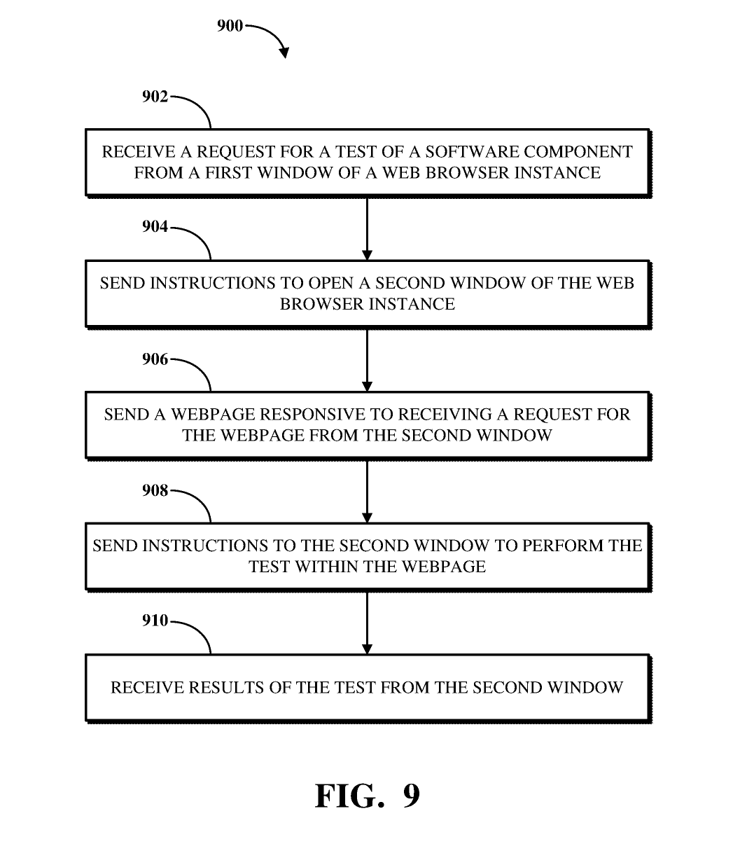

FIG. 9 is a flowchart illustrating an example of a technique 900 for testing behavior of an instance of web application software using windows of a web browser instance. In some implementations, the technique 900 can be executed using computing devices, such as the systems, modules, or devices described with respect to FIGS. 1 through 4. In some implementations, the technique 900 can be performed, for example, by executing a machine-readable program or other computer-executable instructions, such as instructions or programs described according to JavaScript, C, or other such instructions. The steps, or operations, of the technique 900, or any other method, process, or algorithm described in connection with the implementations disclosed herein, can be implemented directly in hardware, firmware, software executed by hardware, circuitry, or a combination thereof.

In some implementations, the technique 900 includes receiving a request for a test of a software component from a first window of a web browser instance 902, sending instructions from the software to open a second window of the web browser instance 904, sending the webpage responsive to receiving a request for the webpage from the second window 906, sending instructions to the second window to perform the test within the webpage 908, and receiving results of the test from the second window.

At 902, a request is received for testing a component of an instance of web application software. The test can include steps for simulating the effects of an update to the instance of web application software, which steps can be configured by a user based, for example, on the type of web application software, the component or components to be tested, the data stored in a database accessible by the instance of web application software relative to the component or components to be tested, or the like, or a combination thereof. The request can be generated responsive to receiving a command from a user to initiate performance of the test, which command can be received via a user interacting with a user interface element of the instance of web application software. In some implementations, a test dashboard or like graphical user interface of the web application software can be a first webpage processed in a first window of a web browser instance executing on a client. The command to initiate performance of the test can be triggered by a user of the client clicking on a “Run Test” or like button of the first webpage. In some implementations, the request can include instructions to query a database table or like logical data structure storing data to be used for performing the test. For example, an instance of platform software can receive the request and process the request by identifying the data associated with the test within a test table of the database accessible by the instance of platform software, the records of which test table being limited to those records representing steps of the test to be performed.

At 904, instructions are sent from the instance of web application software for the web browser instance to open a second window for processing a second webpage. The instructions are received responsive to the request generated at 902 being transmitted to the instance of web application software. In some implementations, the instructions are instructions for the first window to perform the test, including by the first window interacting with the instance of web application software to open the second window (e.g., rather than the instance of web application software interacting directly with the web browser instance). The instructions can include instructions interpretable by an API of the web browser instance such that the instructions can be processed by the web browser instance without conversion or the like. The instructions can cause a second window to open within the web browser instance, wherein the second window can process a second webpage different from the first webpage processed in the first window. The instructions of 904 can be sent from the instance of web application software to the first window using an AMB channel or like communications channel.

At 906, the second webpage is sent from the instance of web application software to the web browser instance responsive to a request for the webpage from the second window. The second webpage is a webpage via which the test can be performed against the respective components of the instance of web application software, which second webpage may, for example, include a container for embedding further webpages associated with the components of the instance of web application software under test (e.g., the container 410 shown in FIG. 4). At 908, instructions to perform the test from the second webpage are processed. In some implementations, the instructions to control the test can be received from the instance of web application software responsive to the instance of web application software receiving an indication that the second window has been opened within the web browser instance. The instructions to control the test are received from the instance of web application software by the first window of the web browser instance. The instructions to control the test can include instructions for the second window to dedicate the memory and processor cycles allotted thereto for use in performing the test. The instructions of 904 can be sent from the instance of web application software to the first window using an AMB channel or like communications channel. In some implementations, 904 and 906 can be performed as a single operation.

The test is performed in the second webpage processed by the second window. In some implementations, where instructions to perform the entire test are received previously, 908 can include performing the entire test within the second window. In some implementations, where instructions to perform one or more steps of the test (e.g., a batch of test steps), but not the entire test, are received previously, 908 can include performing that step of the test within the second window. A batch of test steps can include one or more test steps that are related to a common form, database record, etc. For example, a batch test steps can include test steps directed to opening a form, setting values for fields of the form, asserting the values, and submitting the form. In another example, a batch of test steps can include test steps directing to authenticating a user's access to a form and trying to open the form using the user's authenticated (or unauthenticated, as the case may be) access.

The second window can receive data indicative of the component under test (e.g., a form of an instance of platform software), including data indicating pre-test values for elements of the component (e.g., fields of the form) from a table storing the data associated with forms (or other components) under test and values thereof changed by the test from a table storing the test data. Performing the test can include applying values from the test data table to corresponding fields of the data table. Data associated with forms (or other components) under test can be recorded so that all of the changes made thereto can be reverted after the test has been completed, for example, as described above.

At 910, results of the test transmitted from the second window to the instance of web application software. The results can be results of a step of a test associated with a component under test and are generated by the second webpage and can include a record indicating changed values of the copied data described with respect to 908 or successes or failures of the test based on the changed values. In some implementations where the first and second window operate in a same web browser on a same client, the second window can locally cache the results within a memory of the client executing the web browser instance, such that the first window can retrieve the results from the cache and transmit the results to the instance of web application software. The results can be sent from the second window to the instance of web application software using an AMB channel or like communications channel.

Although the technique 900 is shown as a series of operations for clarity, implementations of the technique 900, or any other method, process, or algorithm described in connection with the implementations disclosed herein, can be performed in various orders or concurrently. Additionally, operations in accordance with this disclosure can be performed with other operations not presented and described herein. Furthermore, one or more aspects of the systems and techniques described herein can be omitted.

For example, the technique 900 can include determining whether a testing conflict exists with respect to the component to be tested prior to performing the test at 908. The instructions to control the test sent from the instance of web application software at 906 can be sent responsive to the instance of web application software determining that it has not already sent instructions for controlling another test including that component to another web browser instance. This can be done by the instance of web application software querying a database or other logical data structure storing data indicative of the tests performable for the instance of web application software for an identifier of the component to be tested to determine whether other tests involve the component. Upon determining that another test does involve that component, the instance of web application software can query data for that test to determine whether that test is currently being performed (e.g., wherein the test result data is stored in a table that includes a state attribute indicating whether a test of a given component is currently being performed, which state attribute may, for example, include a reference to the test currently being performed, such as via a list of current or pending tests).

In another example, the technique 900 can include compiling a list of alterations to make to the instance of web application software based on failures of the test transmitted at 910. The failures can indicate that respective components of the instance of web application software do not properly support values or data changes presented in an update to the instance of web application software, such that the failures can be used to prepare the instance of web application software for the update (or cause it to operate properly post-update, as applicable). The list of alterations can be applied to the instance of web application software to update it from a first software version to a second software version (e.g., from the production environment 304 shown in FIG. 3 to the updated production environment 310 shown therein).

All or a portion of the implementations of the systems and techniques described herein can be implemented using a general-purpose computer/processor with a computer program that, when executed, carries out any of the respective techniques, algorithms, or instructions described herein. In addition, or alternatively, for example, a special-purpose computer/processor can be utilized, which can include specialized hardware for carrying out any of the techniques, algorithms, or instructions described herein.

The implementations of computing devices as described herein (and the algorithms, techniques, instructions, etc., stored thereon or executed thereby) can be realized in hardware, software, or a combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination.

For example, one or more computing devices can include an ASIC or programmable logic array (e.g., a field-programmable gate array (FPGA)) configured as a special-purpose processor to perform one or more of the operations described or claimed herein. An example FPGA can include a collection of logic blocks and random access memory (RAM) blocks that can be individually configured or configurably interconnected in order to cause the FPGA to perform certain functions. Certain FPGAs can contain other general- or special-purpose blocks as well. An example FPGA can be programmed based on a hardware definition language (HDL) design, such as VHSIC Hardware Description Language or Verilog.

The implementations disclosed herein can be described in terms of functional block components and various processing operations. Such functional block components can be realized by any number of hardware or software components that perform the specified functions. For example, the described implementations can employ various integrated circuit components (e.g., memory elements, processing elements, logic elements, look-up tables, and the like), which can carry out a variety of functions under the control of one or more microprocessors or other control devices. Similarly, where the elements of the described implementations are implemented using software programming or software elements, the systems and techniques can be implemented with any programming or scripting language, such as C, C++, Java, assembler, or the like, with the various algorithms being implemented with a combination of data structures, objects, processes, routines, or other programming elements. Functional aspects can be implemented in algorithms that execute on one or more processors. Furthermore, the implementations of the systems and techniques could employ any number of conventional techniques for electronics configuration, signal processing or control, data processing, and the like. The words “mechanism” and “element” are used broadly and are not limited to mechanical or physical implementations, but can include software routines in conjunction with processors, etc.

Likewise, the terms “module” or “monitor” as used herein and in the figures may be understood as corresponding to a functional unit implemented using software, hardware (e.g., an ASIC), or a combination of software and hardware. In certain contexts, such modules or monitors may be understood to be a processor-implemented software module or software-implemented monitor that is part of or callable by an executable program, which may itself be wholly or partly composed of such linked modules or monitors.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device. Other suitable mediums are also available. Such computer-usable or computer-readable media can be referred to as non-transitory memory or media, and can include RAM or other volatile memory or storage devices that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

The word “example” is used herein to mean serving as an example, instance, or illustration. Any aspect or design described herein as “example” is not necessarily to be construed as preferred or advantageous over other aspects or designs. Rather, the use of the word “example” is intended to present concepts in a concrete fashion. The use of any and all examples, or language suggesting that an example is being described (e.g., “such as”), provided herein is intended merely to better illuminate the systems and techniques and does not pose a limitation on the scope of the systems and techniques unless otherwise claimed. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. For example, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

The particular implementations shown and described herein are illustrative examples of the systems and techniques and are not intended to otherwise limit the scope of the systems and techniques in any way. For the sake of brevity, conventional electronics, control systems, software development, and other functional aspects of the systems (and components of the individual operating components of the systems) cannot be described in detail. Furthermore, the connecting lines, or connectors, shown in the various figures presented are intended to represent example functional relationships or physical or logical couplings between the various elements. Many alternative or additional functional relationships, physical connections, or logical connections can be present in a practical device. Moreover, no item or component is essential to the practice of the systems and techniques unless the element is specifically described as “essential” or “critical.”

The use of the terms “including,” “comprising,” “having,” or variations thereof herein is meant to encompass the items listed thereafter and equivalents thereof as well as additional items. Unless specified or limited otherwise, the terms “mounted,” “connected,” “supported,” “coupled,” or variations thereof are used broadly and encompass both direct and indirect mountings, connections, supports, and couplings. Further, “connected” and “coupled” are not restricted to physical or mechanical connections or couplings.

Unless otherwise indicated herein, the recitation of ranges of values herein is intended merely to serve as a shorthand alternative to referring individually to respective separate values falling within the range, and respective separate values are incorporated into the specification as if individually recited herein. Finally, the operations of all techniques described herein are performable in any suitable order unless clearly indicated otherwise by the context.

All references, including publications, patent applications, and patents, cited herein are hereby incorporated by reference to the same extent as if respective references were individually and specifically indicated as being incorporated by reference and were set forth in its entirety herein.

The above-described implementations have been described in order to facilitate easy understanding of the present systems and techniques, and such descriptions of such implementations do not limit the present systems and techniques. To the contrary, the present systems and techniques are intended to cover various modifications and equivalent arrangements included within the scope of the appended claims, which scope is to be accorded the broadest interpretation as is permitted by law so as to encompass all such modifications and equivalent arrangements.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system for testing behavior of a first instance of web application software using a plurality of windows of a web browser instance executed by a client device, the system comprising:
a memory; and
a processor,
wherein the memory includes instructions executable by the processor to:
receive a first request from a first window of the web browser instance, the first request indicating at least a first test of at least a first component of the first instance of the web application software;
send first instructions to the first window in response to the first request, wherein the first instructions cause the web browser instance to open a second window of the web browser instance and request a webpage from the first instance of the web application software from the second window;
send the webpage to the client device responsive to a second request received from the second window, wherein the second request is for the webpage;
send second instructions to the second window to perform at least the first test using the second window and the webpage; and
receive test results from the second window responsive to a performance of at least the first test against at least the first component.

2. The system of claim 1, wherein the test results received from the second window comprise records indicating successes or failures of respective components of the first instance of the web application software responsive to elements of the first test being applied to the respective components.

3. The system of claim 2, wherein the first instance of the web application software is a first software version and a second instance of the web application software is a second software version, and wherein the instructions include instructions executable by the processor to:
determine alterations to make to the first instance of the web application software when updating from the first software version to the second software version, wherein the alterations are based on records indicating failures of components of the first software version, and wherein the second instance is updated from the first software version to the second software version using the alterations.

4. The system of claim 3, wherein a database stores data used by the first instance of the web application software, wherein the data is associated with components of the first instance of the web application software for which records indicating successes or failures are generated, and wherein the instructions include instructions executable by the processor to:
cause data stored in the database and associated with a component of the first instance of the web application software to be updated based on one or more of the determined alterations that correspond to the component.

5. The system of claim 3, wherein the first instance of the web application software is a test instance comprising a new installation of a production instance of the web application software comprising the first software version, wherein the first test is performed on the test instance such that the alterations are determined when updating the test instance to the second software version, and wherein the second instance of the web application software is an updated production instance of the web application software comprising the second software version.

6. The system of claim 2, wherein the test results are results of a first step of the first test, wherein results of a second step of the first test are received from the second window responsive to a performance of the second step, wherein the results of the first step and the results of the second step include third instructions to change data stored in a database associated with the first instance of the web application software, and wherein the instructions include instructions executable by the processor to:
responsive to a completion of the performance of the first test, use the results of the first step and the results of the second step to revert changes made to the data stored in the database.

7. The system of claim 2, wherein the test results are results of a first step of the first test, and wherein the results of the first step are used as input for a performance of a second step of the first test.

8. The system of claim 1, wherein, responsive to fourth instructions indicating a testing conflict with a second test, the processor delays sending the second instructions to the second window until the testing conflict is resolved.

9. The system of claim 1, wherein the first instance of the web application software is an instance of platform software and the first test includes changing values in a database associated with the instance of the platform software.

10. A method for testing behavior of a first instance of web application software using a plurality of windows of a web browser instance executed by a client device, the method comprising:
receiving a first request from a first window of the web browser instance, the first request indicating at least a first test of at least a first component of the first instance of the web application software;
sending first instructions to the first window in response to the first request, wherein the first instructions cause the web browser instance to open a second window of the web browser instance and request a webpage from the first instance of the web application software from the second window;
sending the webpage to the client device responsive to receiving a second request from the second window, wherein the second request is for the webpage;
sending second instructions to the second window to perform at least the first test using the second window and the webpage; and
receiving test results from the second window responsive to a performance of at least the first test against at least the first component.

11. The method of claim 10, wherein the test results received from the first window comprise records indicating successes or failures of respective components of the first instance of the web application software responsive to elements of the first test being applied to the respective components.

12. The method of claim 11, wherein the first instance of the web application software is a first software version and a second instance of the web application software is a second software version, and wherein the method further comprises:
determining alterations to make to the first instance of the web application software when updating from the first software version to the second software version, wherein the alterations are based on records indicating failures of components of the first software version, and wherein the second instance is updated from the first software version to the second software version using the list of alterations.

13. The method of claim 12, wherein a database stores data used by the first instance of the web application software, wherein the data is associated with components of the first instance of web application software for which records indicating successes or failures are generated, and wherein the method further comprises:
causing data stored in the database and associated with a component of the first instance of the web application software to be updated based on one or more of the determined alterations that corresponding to the component.

14. The method of claim 12, wherein the first instance of the web application software is a test instance comprising a new installation of a production instance of the web application software comprising the first software version, wherein the first test is performed on the test instance such that the alterations are determined when updating the test instance to the second software version, and wherein the second instance of the web application software is an updated production instance of the web application software comprising the second software version.

15. The method of claim 11, wherein the test results are results of a first step of the first test, wherein results of a second step of the first test are received from the second window responsive to a performance of the second step, wherein the results of the first step and the results of the second step include third instructions to change data stored in a database associated with the first instance of the web application software, and wherein the method further comprises:
responsive to completing the performance of the first test, using the results of the first step and the results of the second step to revert changes made to the data stored in the database.

16. The method of claim 11, wherein the test results are results of a first step of the first test, and wherein the results of the first step are used as input for performing a second step of the first test.

17. The method of claim 10, wherein, responsive to third instructions indicating a testing conflict with a second test, a performance of the first test in the second webpage is delayed until the testing conflict is resolved.

18. The method of claim 10, wherein the web application software is platform software and the first test includes changing values in a database associated with the first instance.

19. A method for testing an instance of web application software, the method comprising:
sending first instructions for opening a first webpage of the instance of web application software to a first window of a web browser application executing on a first computing device; and
sending second instructions for performing an automated test of a second webpage of the instance of web application software to a second window of the web browser application responsive to receiving a request for the second instructions from the first webpage.

20. The method of claim 19, wherein at least one of the first instructions or the second instructions is sent to the first window from a second computing device.

21. The method of claim 20, wherein the first window transmits results of the automated test generated at the second window to the second computing device.

22. The method of claim 19, wherein the web application software is platform software and the first test includes changing values in a database associated with the first instance.
